(19) United States
(12) Patent Application Publication
(10) Pub. No.: US 2021/0042567 A1
(43) Pub. Date: Feb. 11, 2021

(54) TEXT RECOGNITION

(71) Applicant: BEIJING SENSETIME TECHNOLOGY DEVELOPMENT CO., LTD., Beijing (CN)

(72) Inventor: Xuebo LIU, Beijing (CN)

(21) Appl. No.: 17/078,553

(22) Filed: Oct. 23, 2020

Related U.S. Application Data
(63) Continuation of application No. PCT/CN2020/070568, filed on Jan. 7, 2020.

(30) Foreign Application Priority Data
Apr. 3, 2019 (CN) 201910267233.0

(51) Int. Cl. G06K 9/62; G06K 9/34; G06N 3/08

(52) U.S. Cl. CPC G06K 9/629; G06N 3/08; G06K 9/6289; G06K 9/344

(57) ABSTRACT

A method for text recognition includes: feature extraction is performed on a text image to obtain feature information of the text image; and a text recognition result of the text image is acquired according to the feature information, the text image including at least two characters, the feature information including a text association feature, and the text association feature being configured to represent an association between characters in the text image.

### CROSS-REFERENCE TO RELATED APPLICATIONS

This application is a continuation of International Application No. PCT/CN2020/070568, filed on Jan. 7, 2020, which claims priority to Chinese patent application No. 201910267233.0, filed on Apr. 3, 2019. The disclosures of International Application No. PCT/CN2020/070568 and Chinese patent application No. 201910267233.0 are hereby incorporated by reference in their entireties.

### BACKGROUND

During recognition of texts in an image, there are often cases where the texts in the to-be-recognized image are distributed unevenly. For example, multiple characters are distributed along a horizontal direction of the image, and a single character is distributed along a vertical direction, which results in the uneven distribution of the texts. Such type of images cannot be well processed by common methods for text recognition.

### SUMMARY

The disclosure relates to image processing technologies, and more particularly to text recognition.

The disclosure provides text recognition technical solutions.

According to an aspect of the disclosure, a method for text recognition is provided, which may include: feature extraction is performed on a text image to obtain feature information of the text image; and a text recognition result of the text image is acquired according to the feature information, the text image including at least two characters, the feature information including a text association feature, and the text association feature being configured to represent an association between characters in the text image.

According to another aspect of the disclosure, an apparatus for text recognition is provided, which may include: a feature extraction module, configured to perform feature extraction on a text image to obtain feature information of the text image; and a result acquisition module, configured to acquire a text recognition result of the text image according to the feature information, the text image including at least two characters, the feature information including a text association feature, and the text association feature being configured to represent an association between characters in the text image.

According to another aspect of the disclosure, an electronic device is provided, which may include: a memory storing processor-executable instructions; and a processor arranged to execute the stored processor-executable instructions to perform operations of: performing feature extraction on a text image to obtain feature information of the text image; and acquiring a text recognition result of the text image according to the feature information, the text image comprises at least two characters, the feature information comprises a text association feature, and the text association feature is configured to represent an association between characters in the text image.

According to another aspect of the disclosure, an electronic device is provided, which may include: a processor; and a storage medium configured to store instructions executable by the processor, the processor being configured to invoke the instruction stored in the storage medium to execute the above method for text recognition.

According to another aspect of the disclosure, a non-transitory machine-readable storage medium is provided, which stores machine executable instructions that, when executed by a processor, cause the processor to perform a method for text recognition, the method including: performing feature extraction on a text image to obtain feature information of the text image; and acquiring a text recognition result of the text image according to the feature information, where the text image comprises at least two characters, the feature information comprises a text association feature, and the text association feature is configured to represent an association between characters in the text image.

It is to be understood that the above general descriptions and detailed descriptions below are only exemplary and explanatory and not intended to limit the disclosure. According to the following detailed descriptions on the exemplary embodiments with reference to the accompanying drawings, other characteristics and aspects of the disclosure become apparent.

### BRIEF DESCRIPTION OF THE DRAWINGS

The accompanying drawings, which are incorporated in and constitute a part of this specification, illustrate embodiments consistent with the disclosure and, together with the description, serve to explain the principles of the disclosure.

FIG. 1 illustrates a flowchart of a method for text recognition according to an embodiment of the disclosure.

FIG. 2 illustrates a schematic diagram of a network block according to an embodiment of the disclosure.

FIG. 3 illustrates a schematic diagram of a coding network according to an embodiment of the disclosure.

FIG. 4 illustrates a block diagram of an apparatus for text recognition according to an embodiment of the disclosure.

FIG. 5 illustrates a block diagram of an electronic device according to an embodiment of the disclosure.

FIG. 6 illustrates a block diagram of an electronic device according to an embodiment of the disclosure.

### DETAILED DESCRIPTION

Various exemplary embodiments, features and aspects of the disclosure will be described below in detail with reference to the accompanying drawings. A same numeral in the accompanying drawings indicates a same or similar component. The accompanying drawings are unnecessarily drawn according to a proportion unless otherwise specified.

As used herein, the word “exemplary” means “serving as an example, instance, or illustration”. The “exemplary embodiment” is not necessarily to be construed as preferred or advantageous over other embodiments.

The term “and/or” used herein is merely for describing an associated relationship of associated objects, and may represent multiple relationships. For example, A and/or B may indicate three cases: the A exists alone, both the A and the B coexist, and the B exists alone. Besides, the term “at least one type” herein represents any one of multiple types or any combination of at least two types in the multiple types. For example, at least one type of A, B and C may represent any one or multiple elements selected from a set formed by the A, the B and the C.

In addition, for describing the disclosure better, many specific details are presented in the following specific implementations. It is understood by those skilled in the art that the disclosure may still be implemented even without some specific details. In some examples, methods, means, components and circuits known very well to those skilled in the art are not described in detail, to highlight the subject of the disclosure.

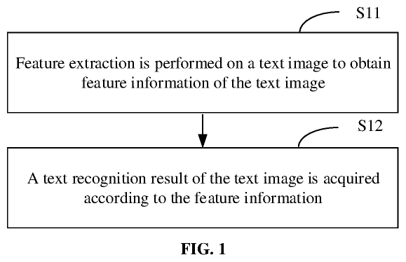

FIG. 1 illustrates a flowchart of a method for text recognition according to an embodiment of the disclosure. The method for text recognition may be executed by a terminal device or other devices. The terminal device may be User Equipment (UE), a mobile device, a user terminal, a terminal, a cell phone, a cordless phone, a Personal Digital Assistant (PDA), a handheld device, a computing device, a vehicle-mounted device, a wearable device, etc.

As shown in FIG. 1, the method may include the following operations.

In S11, feature extraction is performed on a text image to obtain feature information of the text image.

In S12, a text recognition result of the text image is acquired according to the feature information.

The text image includes at least two characters, the feature information includes a text association feature, and the text association feature is configured to represent an association between characters in the text image.

The method for text recognition provided in the embodiment of the disclosure can extract the feature information including the text association feature, the text association feature representing the association between the text characters in the image, and acquire the text recognition result of the image according to the feature information, thereby improving the accuracy of text recognition.

For example, the text image may be an image acquired by an image acquisition device (such as a camera) and including the characters, such as a certificate image photographed in an online identity verification scenario and including the characters. The text image may also be an image downloaded from an Internet, uploaded by a user or acquired in other manners, and including the characters. The source and type of the text image are not limited in the disclosure.

In addition, the “character” mentioned in the specification may include any text character such as a text, a letter, a number and a symbol, and the type of the “character” is not limited in the disclosure.

In some embodiments, in operation S11 that the feature extraction is performed on the text image to obtain the feature information of the text image, the feature information may include the text association feature which is configured to represent the association between the text characters in the text image, such as a distribution sequence of each character, and a probability that several characters appear concurrently.

In some embodiments, operation S11 may include: the feature extraction processing is performed on the text image through at least one first convolutional layer to obtain the text association feature of the text image, a convolution kernel of the first convolutional layer having a size of P×Q, where both P and Q are an integer, and Q>P≤1.

For example, the text image may include at least two characters. The characters may be distributed unevenly in different directions. For example, multiple characters are distributed along a horizontal direction, and a single character is distributed along a vertical direction. In such a case, the convolutional layer performing the feature extraction may use the convolution kernel that is asymmetric in size in different directions, so as to better extract the text association feature in the direction with more characters.

In some embodiments, the feature extraction processing is performed on the text image through at least one first convolutional layer with the convolution kernel having the size of P×Q, so as to be adapted for the image with uneven character distribution. When the number of characters in the horizontal direction is greater than the number of characters in the vertical direction in the text image, it may be assumed that Q>P≤1 to better extract semantic information (text association feature) in the horizontal direction (transverse direction). In some embodiments, the difference between Q and P is greater than a threshold. For example, when the characters in the text image are multiple words arranged transversely (such as a single row), the first convolutional layer may use the convolution kernel having the size of 1×5, 1×7, 1×9, etc.

In some embodiments, when the number of characters in the horizontal direction is smaller than the number of characters in the vertical direction in the text image, it may be assumed that P>Q≥1 to better extract semantic information (text association feature) in the vertical direction (longitudinal direction). For example, when the characters in the text image are multiple words arranged longitudinally (such as a single column), the first convolutional layer may use the convolution kernel having the size of 5×1, 7×1, 9×1, etc. The number of the first convolutional layers and the special size of the convolution kernel are not limited in the disclosure.

By means of such a manner, the text association feature in the direction with more characters in the text image may be better extracted, thereby improving the accuracy of text recognition.

In some embodiments, the feature information further includes a text structural feature; and operation S11 may include: feature extraction processing is performed on the text image through at least one second convolutional layer to obtain the text structural feature of the text image, a convolution kernel of the second convolutional layer having a size of N×N, where N is an integer greater than 1.

For example, the feature information of the text image further includes the text structural feature which is configured to represent spatial structural information of the text, such as a structure of the character, a shape, crudeness or fineness of a stroke, a font type or font angle or other information. In such a case, the convolutional layer performing the feature extraction may use the convolution kernel that is symmetric in size in different directions, so as to better extract the spatial structural information of each character in the text image to obtain the text structural feature of the text image.

In some embodiments, the feature extraction processing is performed on the text image through the at least one second convolutional layer with the convolution kernel having the size of N×N to obtain the text structural feature of the text image, where N is an integer greater than 1. For example, N may be 2, 3, 5, etc., i.e., the second convolutional layer may use the convolution kernel having the size of 2×2, 3×3, 3×5, etc. The number of the second convolutional layers and the special size of the convolution kernel are not limited in the disclosure. By means of such a manner, the text structural feature of the characters in the text image can be extracted, thereby improving the accuracy of text recognition.

In some embodiments, the operation that the feature extraction is performed on the text image to obtain the feature information of the text image may include the following operations.

Downsampling processing is performed on the text image to obtain a downsampling result.

The feature extraction is performed on the downsampling result to obtain the feature information of the text image.

For example, before the feature extraction of the text image, the downsampling processing is first performed on the text image through a downsampling network. The downsampling network includes at least one convolutional layer. The convolution kernel of the convolutional layer is, for example, 3×3 in size. The downsampling result is respectively input to at least one first convolutional layer and at least one second convolutional layer for the feature extraction to obtain the text association feature and the text structural feature of the text image. With the downsampling processing, the calculation amount of the feature extraction may further be reduced and the operation speed of the network is improved; furthermore, the influence of the unbalanced data distribution on the feature extraction is avoided.

In some embodiments, the text recognition result of the text image may be acquired in operation S12 according the feature information obtained in operation S11.

In some embodiments, the text recognition result is a result after the feature information is classified. The text recognition result is, for example, one or more prediction result characters having a maximum prediction probability for the characters in the text image. For example, the characters at positions 1, 2, 3 and 4 in the text image are predicted as “ [symbol] ”. The text recognition result is further, for example, a prediction probability for each character in the text image. For example, when the four Chinese words of “ [symbol] ” are at the positions 1, 2, 3 and 4 in the text image, the corresponding text recognition result includes: the probability of predicting the character at the position 1 as “ [symbol] ” is 85% and the probability of predicting the character as “ [symbol] ” is 98%; the probability of predicting the character at the position 2 as “ [symbol] ” is 60% and the probability of predicting the character as “ [symbol] ” is 90%; the probability of predicting the character at the position 3 as “ [symbol] ” is 65% and the probability of predicting the character as “ [symbol] ” is 94%; and the probability of predicting the character at the position 4 as “ [symbol] ” is 70% and the probability of predicting the character as “ [symbol] ” is 90%. The expression form of the text recognition result is not limited in the disclosure.

In some embodiments, the text recognition result may be acquired according to only the text association feature, and the text recognition result may also be acquired according to both the text association feature and the text structural feature, which are not limited in the disclosure.

In some embodiments, operation S12 may include the following operations.

Fusion processing is performed on the text association feature and the text structural feature included in the feature information to obtain a fused feature.

The text recognition result of the text image is acquired according to the fused feature.

In the embodiment of the disclosure, the convolutional processing may be respectively performed on the text image through different convolutional layers having different sizes of the convolution kernel, to obtain the text association feature and the text structural feature of the text image. Then, the obtained text association feature and text structural feature are fused to obtain the fused feature. The “fusion” processing may be, for example, an operation of adding output results of the different convolutional layers on a pixel-by-pixel basis. Thus, the text recognition result of the text image is acquired according to the fused feature. The obtained fused feature can indicate the text information more completely, thereby improving the accuracy of text recognition.

In some embodiments, the method for text recognition is implemented by a neutral network, a coding network in the neutral network includes multiple network blocks, and each network block includes a first convolutional layer with a convolution kernel having a size of P×Q and a second convolution layer with a convolution kernel having a size of N×N, input ends of the first convolutional layer and the second convolution layer being respectively connected to an input end of the network block.

In some embodiments, the neutral network is, for example, a convolutional neutral network. The specific type of the neutral network is not limited in the disclosure.

For example, the neutral network may include a coding network, the coding network includes multiple network blocks, and each network block includes a first convolutional layer with a convolution kernel having a size of P×Q and a second convolutional layer with a convolution kernel having a size of N×N to respectively extract the text association feature and the text structural feature of the text image. Input ends of the first convolutional layer and the second convolutional layer are respectively connected to an input end of the network block, such that input information of the network block can be respectively input to the first convolutional layer and the second convolutional layer for the feature extraction.

In some embodiments, in front of the first convolutional layer and the second convolutional layer, a third convolutional layer with a convolution kernel having a size of 1×1 and the like may be respectively provided to perform dimension reduction processing on the input information of the network block; and the input information subjected to the dimension reduction processing is respectively input to the first convolutional layer and the second convolutional layer for the feature extraction, thereby effectively reducing the calculation amount of the feature extraction.

In some embodiments, the operation that the fusion processing is performed on the text association feature and the text structural feature to obtain the fused feature may include: a text association feature output by a first convolutional layer of the network block and a text structural feature output by a second convolutional layer of the network block are fused to obtain a fused feature of the network block.

The operation that the text recognition result of the text image is acquired according to the fused feature may include: residual processing is performed on the fused feature of the network block and input information of the network block to obtain output information of the network block; and the text recognition result is obtained based on the output information of the network block.

For example, for any network block, the text association feature output by the first convolutional layer of the network block and the text structural feature output by the second convolutional layer of the network block may be fused to obtain the fused feature of the network block; and the obtain fused feature can indicate the text information more completely.

In some embodiments, the residual processing is performed on the fused feature of the network block and the input information of the network block to obtain the output information of the network block; and the text recognition result is obtained based on the output information of the network block. The “residual processing” herein uses a technology similar to residual learning in a Residual Neural Network (ResNet). By use of residual connection, each network block only needs to learn the difference (the output information of the network block) between the output fused feature and the input information, and does not need to learn all features, such that the learning is converged more easily, and thus the calculation amount of the network block is reduced and the network block is trained more easily.

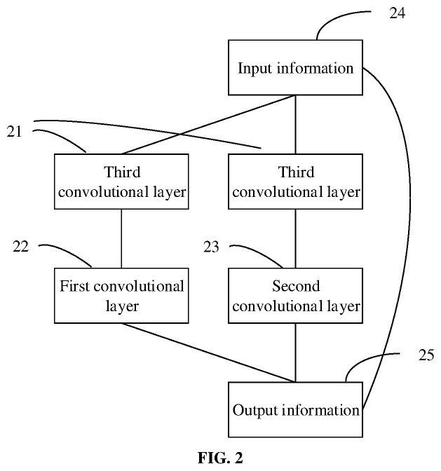

FIG. 2 illustrates a schematic diagram of a network block according to an embodiment of the disclosure. As shown in FIG. 2, the network block includes a third convolutional layer 21 with a convolution kernel having a size of 1×1, a first convolutional layer 22 with a convolution kernel having a size of 1×7 and a second convolutional layer 23 with a convolution kernel having a size of 3×3. Input information 24 of the network block is respectively input to two third convolutional layers 21 for dimension reduction processing, thereby reducing the calculation amount of the feature extraction. The input information subjected to the dimension reduction processing is respectively input to the first convolutional layer 22 and the second convolutional layer 23 for the feature extraction to obtain a text association feature and a text structural feature of the network block.

In some embodiments, the text association feature output by the first convolutional layer of the network block and the text structural feature output by the second convolutional layer of the network block are fused to obtain a fused feature of the network block, thereby indicating the text information more completely. The residual processing is performed on the fused feature of the network block and the input information of the network block to obtain output information 25 of the network block. The text recognition result of the text image may be acquired according to the output information of the network block.

In some embodiments, the coding network in the neutral network includes a downsampling network and multiple stages of feature extraction networks cascaded to an output end of the downsampling network, each stage of feature extraction network including at least one network block and a downsampling module connected to an output end of the at least one network block.

For example, the feature extraction may be performed on the text image through the multiple stages of feature extraction networks. In such a case, the coding network in the neutral network includes a downsampling network and multiple stages of feature extraction networks cascaded to an output end of the downsampling network. The text image is input to the downsampling network (including at least one convolutional layer) for downsampling processing, thereby outputting a downsampling result; and the downsampling result is input to the multiple stages of feature extraction networks for the feature extraction, such that the feature information of the text image may be obtained.

In some embodiments, the downsampling result of the text image is input to a first stage of feature extraction network for the feature extraction, thereby outputting output information of the first stage of feature extraction network; then, the output information of the first stage of feature extraction network is input to a second stage of feature extraction network, thereby outputting output information of the second stage of feature extraction network; and by the same reasoning, output information of a last stage of feature extraction network may be used as final output information of the coding network.

Each stage of feature extraction network includes at least one network block and a downsampling module connected to an output end of the at least one network block. The downsampling module includes at least one convolutional layer. The downsampling module may be connected at the output end of each network block, and the downsampling module may also be connected at the output end of the last network block of each stage of feature extraction network. In this way, the output information of each stage of feature extraction network is input into a next stage of feature extraction network again by downsampling, thereby reducing the feature size and the calculation amount.

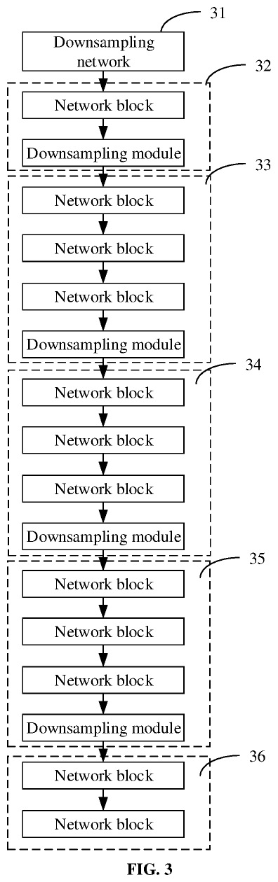

FIG. 3 illustrates a schematic diagram of a coding network according to an embodiment of the disclosure. As shown in FIG. 3, the coding network includes a downsampling network 31 and five stages of feature extraction networks 32, 33, 34, 35, 36 cascaded to an output end of the downsampling network. The first stage of feature extraction network 32 to the fifth stage of feature extraction network 36 respectively include 1, 3, 3, 3, 2 network blocks; and an output end of a last network block of each stage of feature extraction network is connected to the downsampling module.

In some embodiments, the text image is input to the downsampling network 31 for downsampling processing to output a downsampling result; the downsampling result is input to the first stage of feature extraction network 32 (network block+downsampling module) for feature extraction to output output information of the first stage of feature extraction network 32; the output information of the first stage of feature extraction network 32 is input to the second stage of feature extraction network 33 to be sequentially processed by three network blocks and downsampling modules, to output output information of the second stage of feature extraction network 33; and by the same reasoning, the output information of the fifth stage of feature extraction network 36 is used as the final output information of the coding network.

Through the downsampling network and the multiple stages of feature extraction networks for the feature extraction, a bottleneck structure may be formed. Therefore, the effect of word recognition can be improved, the calculation amount is reduced obviously, the convergence is achieved more easily during network training, and the training difficulty is lowered.

In some possible implementations, the method may further include that: the text image is preprocessed to obtain a preprocessed text image.

In the implementation of the disclosure, the text image may be a text image including multiple rows or multiple columns. The preprocessing operation may be to segment the text image including the multiple rows or the multiple columns into a single row or single column of text image for recognition.

In some possible implementations, the preprocessing operation may be normalization processing, geometric transformation processing, image enhancement processing and other operations.

In some embodiments, the coding network in the neutral network is trained according to a preset training set. During training, supervised learning is performed on the coding network by using a Connectionist Temporal Classification (CTC) loss. The prediction result of each part of the picture is classified. The closer the classification result to the real result, the smaller the loss. When a training condition is met, a trained coding network may be obtained. The selection of the loss function of the coding network and the specific training manner are not limited in the disclosure.

According to the method for text recognition provided by the embodiment of the disclosure, the text association feature that represents the association between the characters in the image can be extracted through the convolutional layers having asymmetric convolution kernels in size, such that the effect of feature extraction is improved, and the unnecessary calculation amount is reduced; and the text association feature and the text structural feature of the character can be respectively extracted to implement the parallelization of the deep neutral network, and reduce the operation time remarkably.

According to the method for text recognition provided by the embodiment of the disclosure, by using the residual connection and the network structure including the multiple stages of feature extraction networks in the bottleneck structure, the text information in the image can be well captured without a recurrent neural network, the good recognition result can be obtained, and the calculation amount is greatly reduced; and furthermore, the network structure is trained easily, such that the training process can be quickly completed.

The method for text recognition provided by the embodiment of the disclosure may be applied to identity authentication, content approval, picture retrieval, picture translation and other scenarios, to implement the text recognition. For example, in the use scenario of the identity verification, the word content in various types of certificate images such as an identity card, a bank card and a driving license is extracted through the method to complete the identity verification. In the use scenario of the content approval, the word content in the image uploaded by the user in the social network is extracted through the method, and whether the image includes illegal information, such as a content relevant to a violence, is recognized

It can be understood that the method embodiments mentioned in the disclosure may be combined with each other to form a combined embodiment without departing from the principle and logic, which is not elaborated in the embodiments of the disclosure for the sake of simplicity. It can be understood by those skilled in the art that in the method of the specific implementations, the specific execution sequence of each operation may be determined in terms of the function and possible internal logic.

In addition, the disclosure further provides an apparatus for text recognition, an electronic device, a computer-readable storage medium and a program, all of which may be configured to implement any method for text recognition provided by the disclosure. The corresponding technical solutions and descriptions refer to the corresponding descriptions in the method and will not elaborated herein.

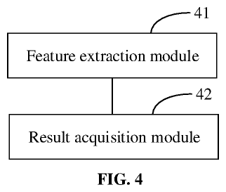

FIG. 4 illustrates a block diagram of an apparatus for text recognition according to an embodiment of the disclosure. As shown in FIG. 4, the apparatus for text recognition may include: a feature extraction module 41 and a result acquisition module 42.

The feature extraction module 41 is configured to perform feature extraction on a text image to obtain feature information of the text image; and the result acquisition module 42 is configured to acquire a text recognition result of the text image according to the feature information, the text image including at least two characters, the feature information including a text association feature, and the text association feature being configured to represent an association between characters in the text image.

In some embodiments, the feature extraction module may include: a first extraction submodule, configured to perform the feature extraction processing on the text image through at least one first convolutional layer to obtain the text association feature of the text image, a convolution kernel of the first convolutional layer having a size of P×Q, where both P and Q are an integer, and Q>P≥1.

In some embodiments, the feature information further includes a text structural feature; and the feature extraction module may include: a second extraction submodule, configured to perform feature extraction processing on the text image through at least one second convolutional layer to obtain the text structural feature of the text image, a convolution kernel of the second convolutional layer having a size of N×N, where N is an integer greater than 1.

In some embodiments, the result acquisition module may include: a fusion submodule, configured to perform fusion processing on the text association feature and the text structural feature included in the feature information to obtain a fused feature; and a result acquisition submodule, configured to acquire the text recognition result of the text image according to the fused feature.

In some embodiments, the apparatus is applied to a neutral network, a coding network in the neutral network includes multiple network blocks, and each network block includes a first convolutional layer with a convolution kernel having a size of P×Q and a second convolution layer with a convolution kernel having a size of N×N, input ends of the first convolutional layer and the second convolution layer being respectively connected to an input end of the network block.

In some embodiments, the apparatus is applied to a neutral network, a coding network in the neutral network includes multiple network blocks, and the fusion submodule is configured to: fuse a text association feature output by a first convolutional layer of a first network block in the multiple network blocks and a text structural feature output by a second convolutional layer of the first network block to obtain a fused feature of the first network block.

The result acquisition submodule is configured to: perform residual processing on the fused feature of the first network block and input information of the first network block to obtain output information of the first network block; and obtain the text recognition result based on the output information of the first network block.

In some embodiments, the coding network in the neutral network includes a downsampling network and multiple stages of feature extraction networks cascaded to an output end of the downsampling network, each stage of feature extraction network including at least one network block and a downsampling module connected to an output end of the at least one network block.

In some embodiments, the neutral network is a convolutional neural network.

In some embodiments, the feature extraction module may include: a downsampling submodule, configured to perform downsampling processing on the text image to obtain a downsampling result; and a third extraction submodule, configured to perform the feature extraction on the downsampling result to obtain the feature information of the text image.

In some embodiments, the function or included module of the apparatus provided by the embodiment of the disclosure may be configured to perform the method described in the above method embodiments, and the specific implementation may refer to the description in the above method embodiments. For the simplicity, the details are not elaborated herein.

An embodiment of the disclosure further provides a machine-readable storage medium, which stores a machine executable instruction; and the machine executable instruction is executed by a processor to implement the above method. The machine-readable storage medium may be a non-volatile machine-readable storage medium.

An embodiment of the disclosure further provides an electronic device, which may include: a processor; and a storage medium configured to store instructions executable by the processor, the processor being configured to invoke the instruction stored in the storage medium to execute the above method.

The electronic device may be provided as a terminal, a server or other types of devices.

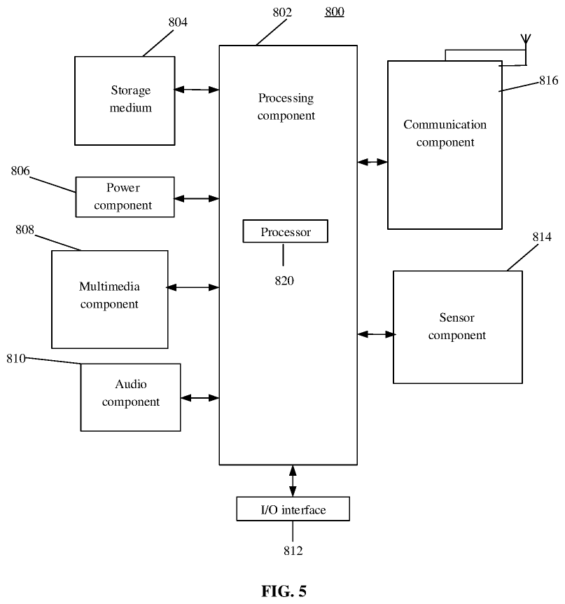

FIG. 5 illustrates a block diagram of an electronic device 800 according to an embodiment of the disclosure. For example, the electronic device 800 may be a terminal such as a mobile phone, a computer, a digital broadcast terminal, a messaging device, a gaming console, a tablet, a medical device, exercise equipment and a PDA.

Referring to FIG. 5, the electronic device 800 may include one or more of the following components: a processing component 802, a memory 804, a power component 806, a multimedia component 808, an audio component 810, an Input/Output (I/O) interface 812, a sensor component 814, and a communication component 816.

The processing component 802 typically controls overall operations of the electronic device 800, such as the operations associated with display, telephone calls, data communications, camera operations, and recording operations. The processing component 802 may include one or more processors 820 to execute instructions to perform all or part of the operations in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the electronic device 800. Examples of such data include instructions for any application or method operated on the electronic device 800, contact data, phonebook data, messages, pictures, videos, etc. The memory 804 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or an optical disc.

The power component 806 provides power to various components of the electronic device 800. The power component 806 may include a power management system, one or more power sources, and any other components associated with the generation, management, and distribution of power in the electronic device 800.

The multimedia component 808 includes a screen providing an output interface between the electronic device 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive external multimedia data when the electronic device 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the electronic device 800 is in an operation mode, such as a call mode, a recording mode, and a voice recognition mode. The received audio signal may further be stored in the memory 804 or transmitted via the communication component 816. In some embodiments, the audio component 810 further includes a speaker configured to output audio signals.

The I/O interface 812 provides an interface between the processing component 802 and peripheral interface modules. The peripheral interface modules may be a keyboard, a click wheel, buttons, and the like. The buttons may include, but are not limited to, a home button, a volume button, a starting button, and a locking button.

The sensor component 814 includes one or more sensors to provide status assessments of various aspects of the electronic device 800. For instance, the sensor component 814 may detect an on/off status of the electronic device 800 and relative positioning of components, such as a display and small keyboard of the electronic device 800, and the sensor component 814 may further detect a change in a position of the electronic device 800 or a component of the electronic device 800, presence or absence of contact between the user and the electronic device 800, orientation or acceleration/deceleration of the electronic device 800 and a change in temperature of the electronic device 800. The sensor component 814 may include a proximity sensor, configured to detect the presence of nearby objects without any physical contact. The sensor component 814 may also include a light sensor, such as a Complementary Metal Oxide Semiconductor (CMOS) or Charge Coupled Device (CCD) image sensor, configured for use in an imaging application. In some embodiments, the sensor component 814 may also include an accelerometer sensor, a gyroscope sensor, a magnetic sensor, a pressure sensor, or a temperature sensor.

The communication component 816 is configured to facilitate wired or wireless communication between the electronic device 800 and another device. The electronic device 800 may access a communication-standard-based wireless network, such as a Wireless Fidelity (WiFi) network, a 2nd-Generation (2G) or 3rd-Generation (3G) network or a combination thereof. In one exemplary embodiment, the communication component 816 receives a broadcast signal or broadcast associated information from an external broadcast management system via a broadcast channel In one exemplary embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

Exemplarily, the electronic device 800 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, micro-controllers, microprocessors or other electronic components, and is configured to execute the abovementioned method.

Exemplarily, a nonvolatile computer-readable storage medium is also provided, for example, a memory 804 including a machine-executable instruction. The machine-executable instruction may be executed by a processor 820 of an electronic device 800 to implement the abovementioned method.

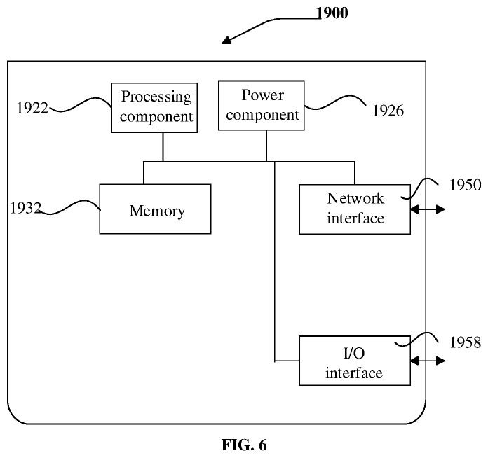

FIG. 6 illustrates a block diagram of an electronic device 1900 according to an embodiment of the disclosure. For example, the electronic device 1900 may be provided as a server. Referring to FIG. 6, the electronic device 1900 includes a processing component 1922, further including one or more processors, and a memory resource represented by a memory 1932, configured to store instructions executable by the processing component 1922, for example, an application program. The application program stored in the memory 1932 may include one or more modules, with each module corresponding to one group of instructions. In addition, the processing component 1922 is configured to execute the instruction to execute the abovementioned method.

The electronic device 1900 may further include a power component 1926 configured to execute power management of the electronic device 1900, a wired or wireless network interface 1950 configured to connect the electronic device 1900 to a network and an I/O interface 1958. The electronic device 1900 may be operated based on an operating system stored in the memory 1932, for example, Windows Server™, Mac OS X™, Unix™, Linux™, FreeBSD™ or the like.

Exemplarily, a nonvolatile computer-readable storage medium is also provided, for example, a memory 1932 including a computer program instruction. The computer program instruction may be executed by a processing component 1922 of an electronic device 1900 to implement the abovementioned method.

The disclosure may be a system, a method and/or a computer program product. The computer program product may include a computer-readable storage medium, in which a computer-readable program instruction configured to enable a processor to implement each aspect of the disclosure is stored

The computer-readable storage medium may be a physical device capable of retaining and storing an instruction used by an instruction execution device. For example, the computer-readable storage medium may be, but not limited to, an electric storage device, a magnetic storage device, an optical storage device, an electromagnetic storage device, a semiconductor storage device or any appropriate combination thereof. More specific examples (non-exhaustive list) of the computer-readable storage medium include a portable computer disk, a hard disk, a Random Access Memory (RAM), a ROM, an EPROM (or a flash memory), an SRAM, a Compact Disc Read-Only Memory (CD-ROM), a Digital Video Disk (DVD), a memory stick, a floppy disk, a mechanical coding device, a punched card or in-slot raised structure with an instruction stored therein, and any appropriate combination thereof. Herein, the computer-readable storage medium is not explained as a transient signal, for example, a radio wave or another freely propagated electromagnetic wave, an electromagnetic wave propagated through a wave guide or another transmission medium (for example, a light pulse propagated through an optical fiber cable) or an electric signal transmitted through an electric wire.

The computer-readable program instruction described here may be downloaded from the computer-readable storage medium to each computing/processing device or downloaded to an external computer or an external storage device through a network such as an Internet, a Local Area Network (LAN), a Wide Area Network (WAN) and/or a wireless network. The network may include a copper transmission cable, an optical fiber transmission cable, a wireless transmission cable, a router, a firewall, a switch, a gateway computer and/or an edge server. A network adapter card or network interface in each computing/processing device receives the computer-readable program instruction from the network and forwards the computer-readable program instruction for storage in the computer-readable storage medium in each computing/processing device.

The computer program instruction configured to execute the operations of the disclosure may be an assembly instruction, an Instruction Set Architecture (ISA) instruction, a machine instruction, a machine related instruction, a microcode, a firmware instruction, state setting data or a source code or target code edited by one or any combination of more programming languages, the programming language including an object-oriented programming language such as Smalltalk and C++ and a conventional procedural programming language such as “C” language or a similar programming language. The computer-readable program instruction may be completely or partially executed in a computer of a user, executed as an independent software package, executed partially in the computer of the user and partially in a remote computer, or executed completely in the remote server or a server. In a case involved in the remote computer, the remote computer may be connected to the user computer via an type of network including the LAN or the WAN, or may be connected to an external computer (such as using an Internet service provider to provide the Internet connection). In some embodiments, an electronic circuit, such as a programmable logic circuit, a Field Programmable Gate Array (FPGA) or a Programmable Logic Array (PLA), is customized by using state information of the computer-readable program instruction. The electronic circuit may execute the computer-readable program instruction to implement each aspect of the disclosure.

Herein, each aspect of the disclosure is described with reference to flowcharts and/or block diagrams of the method, device (system) and computer program product according to the embodiments of the disclosure. It is to be understood that each block in the flowcharts and/or the block diagrams and a combination of each block in the flowcharts and/or the block diagrams may be implemented by computer-readable program instructions.

These computer-readable program instructions may be provided for a universal computer, a dedicated computer or a processor of another programmable data processing device, thereby generating a machine to further generate a device that realizes a function/action specified in one or more blocks in the flowcharts and/or the block diagrams when the instructions are executed through the computer or the processor of the other programmable data processing device. These computer-readable program instructions may also be stored in a computer-readable storage medium, and through these instructions, the computer, the programmable data processing device and/or another device may work in a specific manner, so that the computer-readable medium including the instructions includes a product including instructions for implementing each aspect of the function/action specified in one or more blocks in the flowcharts and/or the block diagrams.

These computer-readable program instructions may further be loaded to the computer, the other programmable data processing device or the other device, so that a series of operating operations are executed in the computer, the other programmable data processing device or the other device to generate a process implemented by the computer to further realize the function/action specified in one or more blocks in the flowcharts and/or the block diagrams by the instructions executed in the computer, the other programmable data processing device or the other device.

The flowcharts and block diagrams in the drawings illustrate probably implemented system architectures, functions and operations of the system, method and computer program product according to multiple embodiments of the disclosure. On this aspect, each block in the flowcharts or the block diagrams may represent part of a module, a program segment or an instruction, and part of the module, the program segment or the instruction includes one or more executable instructions configured to realize a specified logical function. In some alternative implementations, the functions marked in the blocks may also be realized in a sequence different from those marked in the drawings. For example, two continuous blocks may actually be executed substantially concurrently and may also be executed in a reverse sequence sometimes, which is determined by the involved functions. It is further to be noted that each block in the block diagrams and/or the flowcharts and a combination of the blocks in the block diagrams and/or the flowcharts may be implemented by a dedicated hardware-based system configured to execute a specified function or operation or may be implemented by a combination of a special hardware and a computer instruction.

Each embodiment of the disclosure has been described above. The above descriptions are exemplary, non-exhaustive and also not limited to each disclosed embodiment. Many modifications and variations are apparent to those of ordinary skill in the art without departing from the scope and spirit of each described embodiment of the disclosure. The terms used herein are selected to explain the principle and practical application of each embodiment or technical improvements in the technologies in the market best or enable others of ordinary skill in the art to understand each embodiment disclosed herein.

1. A method for text recognition, comprising:
performing feature extraction on a text image to obtain feature information of the text image; and
acquiring a text recognition result of the text image according to the feature information,
wherein the text image comprises at least two characters, the feature information comprises a text association feature, and the text association feature is configured to represent an association between characters in the text image.

2. The method of claim 1, wherein performing the feature extraction on the text image to obtain the feature information of the text image comprises:
performing the feature extraction processing on the text image through at least one first convolutional layer to obtain the text association feature of the text image, wherein a convolution kernel of the first convolutional layer has a size of P×Q, where both P and Q are an integer, and Q>P≥1.

3. The method of claim 1, wherein the feature information further comprises a text structural feature,
wherein performing the feature extraction on the text image to obtain the feature information of the text image comprises:
performing the feature extraction processing on the text image through at least one second convolutional layer to obtain the text structural feature of the text image, wherein a convolution kernel of the second convolutional layer has a size of N×N, where N is an integer greater than 1.

4. The method of claim 1, wherein acquiring the text recognition result of the text image according to the feature information comprises:
performing fusion processing on the text association feature and a text structural feature comprised in the feature information to obtain a fused feature; and
acquiring the text recognition result of the text image according to the fused feature.

5. The method of claim 1, wherein the method is implemented by a neutral network, a coding network in the neutral network comprises multiple network blocks, and each network block comprises a first convolutional layer with a convolution kernel having a size of P×Q and a second convolution layer with a convolution kernel having a size of N×N, wherein input ends of the first convolutional layer and the second convolution layer are respectively connected to an input end of the network block.

6. The method of claim 4, wherein the method is implemented by a neutral network, and a coding network in the neutral network comprises multiple network blocks,
wherein performing the fusion processing on the text association feature and the text structural feature to obtain the fused feature comprises:
fusing a text association feature, output by a first convolutional layer of a first network block in the multiple network blocks, and a text structural feature, output by a second convolutional layer of the first network block, to obtain a fused feature of the first network block; and
acquiring the text recognition result of the text image according to the fused feature comprises:
performing residual processing on the fused feature of the first network block and input information of the first network block to obtain output information of the first network block; and
obtaining the text recognition result based on the output information of the first network block.

7. The method of claim 5, wherein the coding network in the neutral network comprises a downsampling network and multiple stages of feature extraction networks cascaded to an output end of the downsampling network, wherein each stage of feature extraction network comprises at least one network block and a downsampling portion connected to an output end of the at least one network block.

8. The method of claim 5, wherein the neutral network is a convolutional neutral network.

9. The method of claim 1, wherein performing the feature extraction on the text image to obtain the feature information of the text image comprises:
performing downsampling processing on the text image to obtain a downsampling result; and
performing the feature extraction on the downsampling result to obtain the feature information of the text image.

10. An apparatus for text recognition, comprising:
a memory storing processor-executable instructions; and
a processor arranged to execute the stored processor-executable instructions to perform operations of:
performing feature extraction on a text image to obtain feature information of the text image; and
acquiring a text recognition result of the text image according to the feature information,
wherein the text image comprises at least two characters, the feature information comprises a text association feature, and the text association feature is configured to represent an association between characters in the text image.

11. The apparatus of claim 10, wherein performing the feature extraction on the text image to obtain the feature information of the text image comprises:
performing the feature extraction processing on the text image through at least one first convolutional layer to obtain the text association feature of the text image, wherein a convolution kernel of the first convolutional layer has a size of P×Q, where both P and Q are an integer, and Q>P≥1.

12. The apparatus of claim 10, wherein the feature information further comprises a text structural feature,
wherein performing the feature extraction on the text image to obtain the feature information of the text image comprises:
performing the feature extraction processing on the text image through at least one second convolutional layer to obtain the text structural feature of the text image, wherein a convolution kernel of the second convolutional layer has a size of N×N, where N is an integer greater than 1.

13. The apparatus of claim 10, wherein acquiring the text recognition result of the text image according to the feature information comprises:
performing fusion processing on a text association feature and a text structural feature comprised in the feature information to obtain a fused feature; and
acquiring the text recognition result of the text image according to the fused feature.

14. The apparatus of claim 10, wherein the apparatus is applied to a neutral network, a coding network in the neutral network comprises multiple network blocks, and each network block comprises a first convolutional layer with a convolution kernel having a size of P×Q and a second convolution layer with a convolution kernel having a size of N×N, wherein input ends of the first convolutional layer and the second convolution layer are respectively connected to an input end of the network block.

15. The apparatus of claim 13, wherein the apparatus is applied to a neutral network, a coding network in the neutral network comprises multiple network blocks,
wherein performing the fusion processing on the text association feature and the text structural feature to obtain the fused feature comprises
fusing a text association feature output by a first convolutional layer of a first network block in the multiple network blocks and a text structural feature output by a second convolutional layer of the first network block to obtain a fused feature of the first network block; and
acquiring the text recognition result of the text image according to the fused feature comprises:
performing residual processing on the fused feature of the first network block and input information of the first network block to obtain output information of the first network block; and
obtaining the text recognition result based on the output information of the first network block.

16. The apparatus of claim 14, wherein the coding network in the neutral network comprises a downsampling network and multiple stages of feature extraction networks cascaded to an output end of the downsampling network, wherein each stage of feature extraction network comprises at least one network block and a downsampling portion connected to an output end of the at least one network block.

17. The apparatus of claim 14, wherein the neutral network is a convolutional neutral network.

18. The apparatus of claim 10, performing the feature extraction on the text image to obtain the feature information of the text image comprises:
performing downsampling processing on the text image to obtain a downsampling result; and
performing the feature extraction on the downsampling result to obtain the feature information of the text image.

19. A non-transitory machine-readable storage medium, having stored thereon machine executable instructions that, when executed by a processor, cause the processor to perform a method for text recognition, the method comprising:
performing feature extraction on a text image to obtain feature information of the text image; and
acquiring a text recognition result of the text image according to the feature information,
wherein the text image comprises at least two characters, the feature information comprises a text association feature, and the text association feature is configured to represent an association between characters in the text image.

20. The non-transitory machine-readable storage medium of claim 19, wherein performing the feature extraction on the text image to obtain the feature information of the text image comprises:
performing the feature extraction processing on the text image through at least one first convolutional layer to obtain the text association feature of the text image, wherein a convolution kernel of the first convolutional layer has a size of P×Q, where both P and Q are an integer, and Q>P≥1.
